(19) United States
(12) Patent Application Publication
(10) Pub. No.: US 2012/0067438 A1
(43) Pub. Date: Mar. 22, 2012

(54) POLYMER TREATMENT DEVICE FOR PROVIDING A TREATMENT TO A POLYMER BED, A COMPUTER-READABLE MEDIUM ASSOCIATED WITH A CONTROLLER THEREOF, AND AN ASSOCIATED MOLDING SYSTEM

(75) Inventors: Tiemo Dietmar Brand, North York (CA); Alex Teng, Richmond Hill (CA)

(73) Assignee: Husky Injection Molding Systems Ltd., Bolton, ON (CA)

(21) Appl. No.: 13/318,209

(22) PCT Filed: Apr. 8, 2010
(86) PCT No.: PCT/CA2010/000497

§ 371 Date: Oct. 31, 2011

Related U.S. Application Data
(60) Provisional application No. 61/181,700, filed on May 28, 2009.

(51) Int. Cl. F16L 53/00; B29C 45/00

(52) U.S. Cl. 137/334; 425/542

(57) ABSTRACT

Embodiments of the present invention generally relate to a polymer treatment device (100) for providing a treatment to a polymer bed (4) having granules (2) of a polymer that are in a solid- state, a computer-readable medium associated with a controller thereof, and an associated molding system (1000). The polymer treatment device 100 includes a polymer supporter (110) with which to support, in use, the polymer bed (4), a radiant heater (120) with which to heat, in use, the polymer bed (4), a first fluid dispenser (140-1) with which to dispense, in use, a first treatment fluid (102-1), and a first fluid vent (150-1) with which to vent, in use, the first treatment fluid (102-1), along with a diffusate from the polymer bed (4) potentially entrained therewith. Furthermore, the first fluid dispenser (140-1) and the first fluid vent (150-1) are arranged to promote a flow of the first treatment fluid (102-1) through the polymer bed (4) in between the granules (2) thereof.

### TECHNICAL FIELD

Embodiments of the present invention generally relate to a polymer treatment device for providing a treatment to a polymer bed, a computer-readable medium associated with a controller thereof, and an associated molding system.

### BACKGROUND OF THE INVENTION

There exist devices and methods for the treatment of materials in a solid-state that incorporate steps and structure of heating with a radiant heater and passing a treatment fluid over the material.

As an example, U.S. Pat. No. 5,143,626 to Nugent, published on Sep. 1, 1992 discloses an apparatus and process for destroying pathogens and dehydrating streams of waste in one, continuous process. More particularly, the invention contains an auger with specially modified, variably angled blades which agitates a stream of waste. Also, contained in tandem with the auger, a series of variably angled infrared radiate elements are positioned above the auger exposing the moving stream of waste to radiation. Thus, as the waste stream is transported along, the auger blades continually expose the waste stream to the radiation, thereby killing the entrapped pathogens and evaporating the insitu water. Further, the auger and infrared radiation heater elements are encased in a sealed trough, thus sealing in the heat being generated by this process. By sealing the trough, the heat provides excess energy to aid in destroying pathogens and evaporating the insitu water contained in the waste stream, until the water content is less than or equal to five per cent (5%) by unit volume.

In the patent summaries that follow the devices and methods disclosed appear to relate to the treatment, such as drying, of a polymer material, such as, for example, granules of a polymer that have been formed by comminuting plastic bottles, such as those made from Polyethylene terephthalate and the like.

U.S. Pat. No. 5,497,562 to Pikus, published on Mar. 12, 1996, discloses a system for the solid phase polymerization of polymers comprising a crystallizer, and wherein cold amorphous polymer is introduced to the crystallizer. A source of infrared radiation is associated with the crystallizer, and the polymer is heated by applying infrared radiation thereto. The degree of heating is controlled so that the polymer reaches the crystallization or polymerization temperature without exceeding the polymer melting point.

U.S. Pat. No. 5,993,052 to Stricker et al., published on Nov. 30, 1999 discloses a worm or screw conveyor for thermal treatment of a bulk containing thermoplastics and which has an elongated housing along which the bulk material is conveyed by a worm or screw. The worm or screw has a certain peripheral diameter and is rotatable about the worm axis to displace the bulk material therealong and an infrared heater is located in the housing centrally of the peripheral diameter for directly exposing bulk material in the housing to infrared radiant energy to heat the bulk material.

U.S. Pat. No. 6,035,546 to Stricker et al., published on Mar. 14, 2000 discloses a device for thermal treatment of bulk material with a screw conveyor transporting the bulk material which is equipped with infrared heat radiators in a tempering zone, characterized in that the infrared heat radiators are arranged in the screw conveyors in the central area of the rotation diameter. The device is also characterized in that the infrared heat radiators are mounted in a radiation-permeable screw shaft. The walls of a screw trough of the screw conveyor have an infrared-reflecting coating or are made of an infrared-reflecting material.

A commercial example of a polymer treatment device that incorporates steps and structure of heating with a radiant heater and passing a treatment fluid over the material is an infrared dryer such as those sold by NOVATEC Inc., of Baltimore, Md., USA, (www.novatec.com), and KREYENBORG GmbH of Miinster, Germany, (www.kreyenborg.com).

With reference to FIG. 1, there is depicted a polymer treatment device 1 of the prior art that has been structured as an infrared dryer for use in drying a polymer bed 4 having granules 2 of a polymer that are in a solid-state. The device includes, amongst other things, a polymer supporter 10, a radiant heater 20, and a polymer guide 30. The polymer supporter 10 is structured to support, in use, the polymer bed 4. The polymer supporter 10 is provided by a drum 11 that is rotatable about a centerline thereof, on bearings 16, wherein the polymer bed 4 is supported, in use, on a polymer support surface 18 that is an inner surface of the drum 11. The polymer guide 30 is structured to guide, in use, the polymer bed 4 along a polymer flow path within the polymer supporter 10 with rotation of the drum 11. The polymer guide 30 includes a helical vane that is connected to the polymer support surface 18. An inlet 12 and an outlet 13 are defined through a first end wall 24 and a second end wall 25, respectively, that are non-rotatably disposed adjacent to opposite ends of the drum 11. In operation, the granules 2 enter and exit the polymer support 10 through the inlet 12 and the outlet 13, respectively. The radiant heater 20 is arranged within the drum 11 on a frame 22 in a manner such that the radiant heater 20 is able to directly expose the uppermost granules 2 in the polymer bed 4 to radiant energy for sake of a heating thereof. Typically, the radiant heater 20 is operable to emit energy having an infrared wavelength. The frame 22 also includes a conduit (not shown) for introducing air into the polymer treatment device 1, and more particularly for directing the air over the radiant heater 20. The second end wall 25 also defines a vent 50 through which the air, and any diffusate from granules 2 of the polymer may be expelled. In operation, an air flow pathway 6 is established through the polymer treatment device 1, as shown, between the conduit (not shown) and the vent 50. The air flow pathway includes a first portion wherein the air passes over the radiant heater 20 for a cooling thereof and to prevent polymer dust from settling thereon. Next, the air flow pathway includes a second portion wherein the air passes axially along a portion of the drum 11, over a top surface of the polymer bed 4, wherein the air provides for removal of diffusate (mostly in the form of water) therefrom. Lastly, the air flow pathway includes a third portion wherein the air passes up and through the vent 50 to be expelled into the ambient environment. Once dried, the granules 2 of the polymer are typically conveyed from the outlet 13 of the polymer treatment device 1 to a storage silo 60.

For sake of contrast with the foregoing, it is well known to those of skill in the art that there exists other types of devices and methods for the treatment of granules of a polymer such as, for example, those described in the patent summaries that follow.

U.S. Pat. No. 6,703,479 to McGehee et al., published on Mar. 9, 2004 discloses a process and apparatus for heating or cooling polymer solids in a dispensing section of a solid-state polycondensation reactor. Gas is delivered to the dispensing section of the reactor in which it cools polymer solids in the dispensing section by direct heat exchange. Part of the gas is withdrawn at a point proximate to the dispensing section of the reactor and is cooled. The rest of the gas ascends through a reactive section of the reactor and purges polymer solids of impurities. The gas withdrawn from the reactive section of the reactor is oxidized of impurities and dried and then combined with the gas withdrawn proximate to the dispensing section of the reactor. To achieve uniform heating or cooling of the polymer solids in the dispensing section, a preferred ratio of mass flow rate of gas to the mass flow rate of solids is recommended.

US patent application publication 2006/165564 to Cavaglia, published on Jul. 27, 2006 discloses a reactor and a process for solid phase continues polymerisation of polyethylene terephthalate (PET) in order to achieve an increase of the intrinsic viscosity (I.V.) of a low molecular weight PET pre-polymers flow. A plurality of fluidised stages in series are provided and said PET pre-polymers flow is fed into said fluidised stages in series. An inert gas flow is fed either in cross-flow or in counter-current flow with respect to the PET pre-polymers flow.

### SUMMARY OF THE INVENTION

The invention is set forth and characterized in the main claim(s), while the dependent claims describe other characteristics of the invention.

A general aspect of the invention is to provide a polymer treatment device that provides, in use, a treatment to a polymer bed having granules of a polymer that are in a solid-state. The polymer treatment device includes a polymer supporter with which to support, in use, the polymer bed, a radiant heater with which to heat, in use, the polymer bed, a first fluid dispenser with which to dispense, in use, a first treatment fluid, and a first fluid vent with which to vent, in use, the first treatment fluid), along with a diffusate from the polymer bed potentially entrained therewith. Furthermore, the first fluid dispenser and the first fluid vent are arranged to promote a flow of the first treatment fluid through the polymer bed in between the granules thereof.

In another aspect of the invention, there is provided a molding system that includes the polymer treatment device connected to an injection molding machine to provide treated granules of the polymer thereto for further processing, in use, into a molded article.

In yet another aspect of the invention, there is provided a computer-readable medium having computer-executable instructions which, when executed by a controller that is associated with the polymer treatment device result in the polymer treatment device being operable to execute a method of providing the treatment to the polymer bed that is arranged on a polymer supporter therein. The computer-executable instructions for causing heating of the polymer bed with radiant heat energy from the radiant heater, and passing of the first treatment fluid through the polymer bed in between the granules thereof.

These and other aspects and features of non-limiting embodiments of the present invention will now become apparent to those skilled in the art upon review of the following description of specific non-limiting embodiments of the invention in conjunction with the accompanying drawings.

### BRIEF DESCRIPTION OF THE DRAWINGS

The invention and its embodiments will be more fully appreciated by reference to the following detailed description of illustrative (non-limiting) embodiments in accordance with the present invention when taken in conjunction with the accompanying drawings, in which:

FIG. 1 depicts a polymer treatment device of the prior art;

FIG. 2 depicts a polymer treatment device according a first non-limiting embodiment of the present invention;

FIG. 3 depicts a perspective view of a polymer treatment device according to a second non-limiting embodiment of the present invention;

FIG. 4 depicts a perspective view of a section of the polymer treatment device of FIG. 3;

FIG. 5A depicts a side view of an interior portion of a polymer treatment device according to a third non-limiting embodiment of the present invention;

FIG. 5B depicts an enlarged view of an agitator shown in FIG. 5A;

FIG. 6A depicts a side view of an interior portion of a polymer treatment device according to a fourth non-limiting embodiment of the present invention;

FIG. 6B depicts an enlarged view of an agitator shown in FIG. 6A;

FIG. 7 depicts a perspective view of an interior portion of a polymer treatment device according to a fifth non-limiting embodiment of the present invention;

FIG. 8A depicts a side view of an interior portion of a polymer treatment device according to a sixth non-limiting embodiment of the present invention;

FIG. 8B depicts a side view of a section of the polymer treatment device shown in FIG. 8A.

FIG. 9 depicts a perspective view of a portion of a polymer treatment device according to a seventh non-limiting embodiment of the present invention;

FIG. 10 depicts a perspective view of a portion of a polymer treatment device according to an eighth non-limiting embodiment of the present invention;

FIG. 11 depicts a flowchart of a non-limiting embodiment of a method for providing a treatment to a polymer bed 4 using any one of the non-limiting embodiments of the polymer treatment device;

FIG. 12 depicts a perspective view of a molding system according a non-limiting embodiment of the present invention.

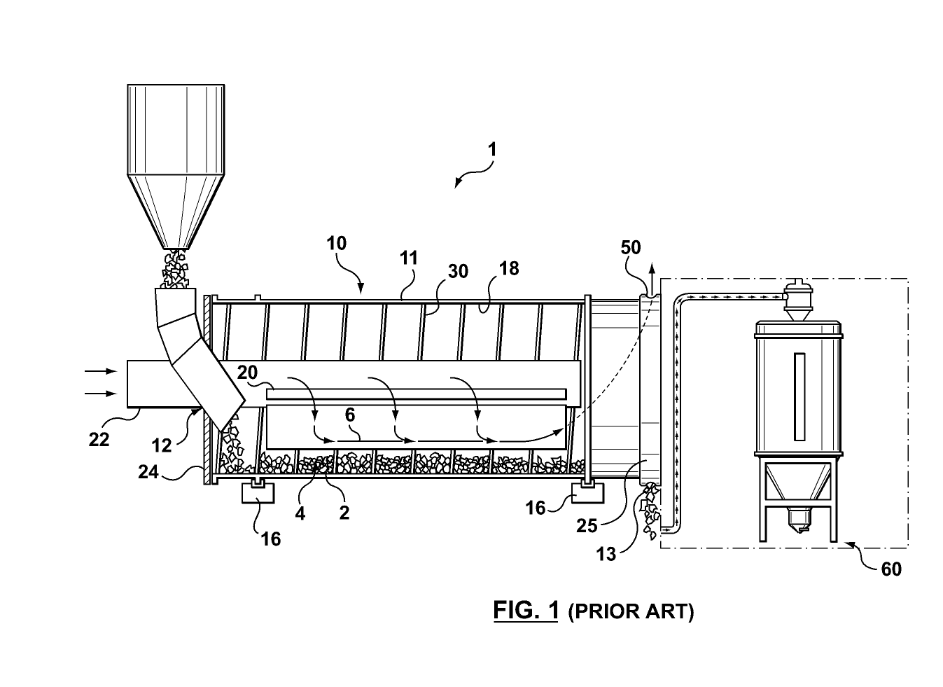

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION OF THE NON-LIMITING EMBODIMENT(S)

The inventor will now describe teachings having to do with new structure and steps for a polymer treatment device of the type for providing a treatment to a polymer bed having granules of a polymer that are in a solid-state. The treatment may include, without specific limitation, one or more of drying, decontaminating, and/or polymerization within the polymer. More particularly, the structure and steps generally relates to the combination of heating the polymer bed with radiant heat energy from a radiant heater while passing a treatment fluid, such as, for example, clean gas (e.g. air, nitrogen, other inert gas, UV inhibiting compound, oxygen scavenging compound, Acetaldehyde absorbent compound, colorant, etc.), through the polymer bed in between the granules thereof by means of a fluid dispenser and a fluid vent, that dispense and vent, respectively the treatment fluid.

A technical effect of the foregoing combination may include an improvement in treatment efficiency relative to the polymer treatment device of the prior art that is attributable to passing of the treatment fluid through the polymer bed.

Reference will now be made to several the non-limiting embodiment(s) of the present invention.

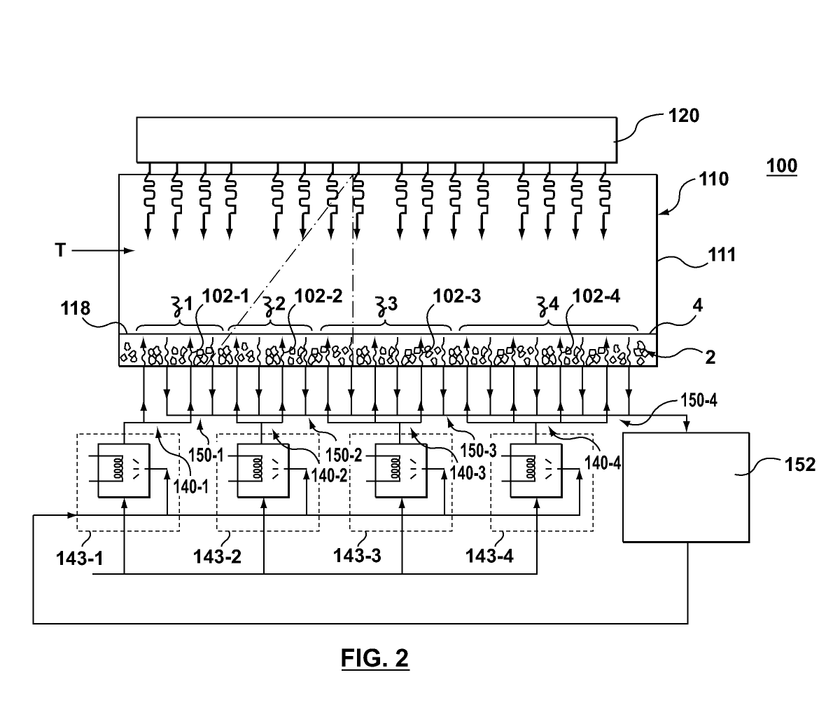

With reference to FIG. 2, there is depicted a first non-limiting embodiment of a polymer treatment device 100 for providing a treatment, in use, to a polymer bed 4 having granules 2 of a polymer that are in a solid-state. The polymer treatment device 100 includes, amongst other things, a polymer supporter 110 with which to support, in use, the polymer bed 4, a radiant heater 120 with which to heat, in use, the polymer bed 4, a first fluid dispenser 140-1 with which to dispense, in use, a first treatment fluid 102-1, and a first fluid vent 150-1 with which to vent, in use, the first treatment fluid 102-1, along with a diffusate (such as, for example, water, ethylene glycol, or contaminants) from the polymer bed 4 potentially entrained therewith. The first fluid dispenser 140-1 and the first fluid vent 150-1 being arranged to promote, in use, a flow of the first treatment fluid 102-1 through the polymer bed 4 in between the granules 2 thereof. More particularly, the first fluid dispenser 140-1 and the first fluid vent 150-1 are positioned, as shown, to be beneath and above the polymer bed 4, respectively, in use, such that the first treatment fluid 102-1 may flow, in use, through the polymer bed.

More particularly, the polymer supporter 110 may be structured to support the polymer bed 4 in situ (i.e. as with a batch-wise treatment) and/or as it is transported along a polymer flow path defined therethrough (i.e. as with a continuous treatment). More particularly, the polymer supporter 110 may be provided by a vessel 111 having a polymer support surface 118 defined therein that supports, in use, the polymer bed 4 thereon. A transport structure (not shown) may furthermore be associated with the polymer supporter 110 with which to transport, in use, the polymer bed 4 along the flow path, generally in a direction of travel ‘T’, as shown, to be subjected to a multi-step treatment as it is passed through a succession of polymer-treatment zones z1, z2, z3, z4 that are defined along the polymer flow path. Of course, other means with which to implement the multi-step treatment may be apparent to those of skill in the art, including, for example, those that are directed to the in situ, batch-wise treatment, of the polymer bed 4. The treatment provided to the granules 2 of the polymer in the various polymer-treatment zones z1, z2, z3, z4 may be the same or different, as will be described with reference to a description, that follows, of various non-limiting embodiments of a method for providing a treatment to the polymer bed 4 within the polymer treatment device 100.

Where the polymer treatment device 100 includes a succession of polymer-treatment zones, the radiant heater 120 may be configured and otherwise controlled to include several heat source zones, such as, for example, through the use of multiple banks of infrared lamp assemblies, whereby temperature control may be provided along the polymer flow path.

The radiant heater 120 may be arranged to directly expose the granules 2 in the polymer bed 4 to radiant energy for sake of a heating thereof. The radiant heater 120 may be arranged above the polymer bed 4. In an alternative non-limiting embodiment (not shown), the radiant heater 120 may be immersed (not shown) within the polymer bed 4. In another alternative non-limiting embodiment (not shown), the radiant heater may be arranged to indirectly expose the granules 2 in the polymer bed 4 to radiant energy for sake of the heating thereof. The radiant heater 120 may be operable to emit energy having an infrared wavelength. As such, the radiant heater 120 may be implemented as an infrared lamp assembly (with or without wavelength modulation) or a pipe heated internally by natural gas and is coated on the outside by material which has high emissivity in the wavelength that the resin will absorb. Other arrangements are possible, including, for example, the radiant heater 120 being operable to emit energy having a microwave wavelength.

Within this particular non-limiting embodiment the first fluid dispenser 140-1 may be arranged in the first zone z1 of the succession of polymer-treatment zones z1, z2, z3, z4. The polymer treatment device 100 may also include a second fluid dispenser 140-2, a third fluid dispenser 140-3, and a fourth fluid dispenser 140-4 with which to dispense, in use, a second treatment fluid 102-2, a third treatment fluid 102-3, and a fourth treatment fluid 102-4, respectively. The second fluid dispenser 140-2, the third fluid dispenser 140-3, and the fourth fluid dispenser 140-4, may be arranged within a second polymer-treatment zone z2, a third polymer-treatment zone z3, and a fourth polymer-treatment zone of the various polymer-treatment zones z1, z2, z3, z4, respectively, although other arrangements are possible. In this way, the application of the treatment fluid may be tailored to the requirements of the particular polymer-treatment zone z1, z2, z3, z4, including, without specific limitation, the type of treatment fluid dispensed (e.g. air, inert gas, water, polymerization reagent, etc.) and certain properties associated therewith (e.g. temperature, velocity, pressure, moisture content, etc.). Accordingly, the polymer treatment device 100 may further include a first conditioning apparatus 143-1, a second conditioning apparatus 143-2, a third conditioning apparatus 143-3, and a fourth conditioning apparatus 143-4 that are connected to the first fluid dispenser 140-1, the second fluid dispenser 140-2, the third fluid dispenser 140-3, and the fourth fluid dispenser 140-4, respectively. The first conditioning apparatus 143-1, the second conditioning apparatus 143-2, the third conditioning apparatus 143-3, and the fourth conditioning apparatus 143-4 being operable to perform a conditioning operation, in use, on the first treatment fluid 102-1, the second treatment fluid 102-2, the third treatment fluid 102-3, and the fourth treatment fluid 102-4, respectively, and wherein the conditioning may include, without specific limitation, one or more of heating, cooling, dehumidifying or humidifying thereof by means such as, for example, heaters, atomizers or polymer membrane plate humidifiers.

Likewise, the first fluid vent 150-1 may be arranged, without specific limitation, in the first polymer-treatment zone z1 of the succession of polymer-treatment zones z1, z2, z3, z4.

Additionally, the polymer treatment device 100 may also include, without specific limitation, a second fluid vent 150-2, a third fluid vent 150-3, a third fluid vent 150-3, and a fourth fluid vent 150-4 with which to vent, in use, the second treatment fluid 102-2, the third treatment fluid 102-3, and the fourth treatment fluid 102-4, respectively, along with a diffusate from the polymer bed 4 potentially entrained therewith. The second fluid vent 150-2, the third fluid vent 150-3, and the fourth fluid vent 150-4, may be arranged within the second polymer-treatment zone z2, the third polymer-treatment zone z3, and the fourth polymer-treatment zone of the various polymer-treatment zones z1, z2, z3, z4, respectively, although other arrangements are possible. In this way, the relative placement of the particular treatment fluid dispenser and fluid vent, within a particular polymer-treatment zone, may be arranged so as to promote the flow of the particular treatment fluid through the polymer bed in between the granules thereof. Moreover, by having the first fluid dispenser 140-1, the second fluid dispenser 140-2, the third fluid dispenser 140-3, and the fourth fluid dispenser 140-4 paired with the first fluid vent 150-1, the second fluid vent 150-2, the third fluid vent 150-3, and the fourth fluid vent 150-4 within the respective polymer-treatment zone z1, z2, z3, z4, it may be possible to compartmentalize the treatment provided to the polymer bed 4 therein and thus further enhance the tailored treatment provided thereto.

One or more of the first fluid vent 150-1, the second fluid vent 150-2, the third fluid vent 150-3, and the fourth fluid vent 150-4 may be further connected, as shown, to a scrubber 152 for remediation of the first treatment fluid 102-1, the second treatment fluid 102-2, the third treatment fluid 102-3, and the fourth treatment fluid 102-4, respectively, prior to its recycling back through to the first fluid dispenser 140-1, the second fluid dispenser 140-2, the third fluid dispenser 140-3, and the fourth fluid dispenser 140-4. The remediation provided to the first treatment fluid 102-1, the second treatment fluid 102-2, the third treatment fluid 102-3, and the fourth treatment fluid 102-4 may include, without specific limitation, condensation and removal of the diffusate that may be entrained therewith. In an alternative non-limiting embodiment (not shown), one or more of the first fluid vent 150-1, the second fluid vent 150-2, the third fluid vent 150-3, and the fourth fluid vent 150-4 may be connected to a dedicated scrubber unit (not shown) of its own such that the first treatment fluid 102-1, the second treatment fluid 102-2, the third treatment fluid 102-3, and the fourth treatment fluid 102-4 may be remediated separately. The scrubber 152 may also remove unwanted fines, chemicals, moisture etc. Also in the case of using nitrogen, the gas may be recovered for recirculation after cleaning.

The control and operation of the structures associated with the polymer treatment device 100 may be performed statically and/or dynamically with the assistance of a process control system (not shown), that may include, for example, a programmable logic controller (PLC) or an industrial PC. The process control system may include provisions for manual and/or automatic control, the latter of which may involve various methodologies of open-loop and/or closed-loop control. Accordingly, the process control system may make use of process control information, and otherwise influence control over the controllable structures of the polymer treatment device 100 to optimize function of each processing stage. The process control information may include, without specific limitation, one or more of granule feed rate monitoring, temperature monitoring, moisture monitoring, intrinsic viscosity measurement and/or chemical composition analysis (as determined by means such as mass and/or spectroscopy gas spectrometer), and other feedback sensors. The control processing variables may include, without specific limitation, one or more of temperature, granule feed rate, and treatment fluid flow rate, etc..

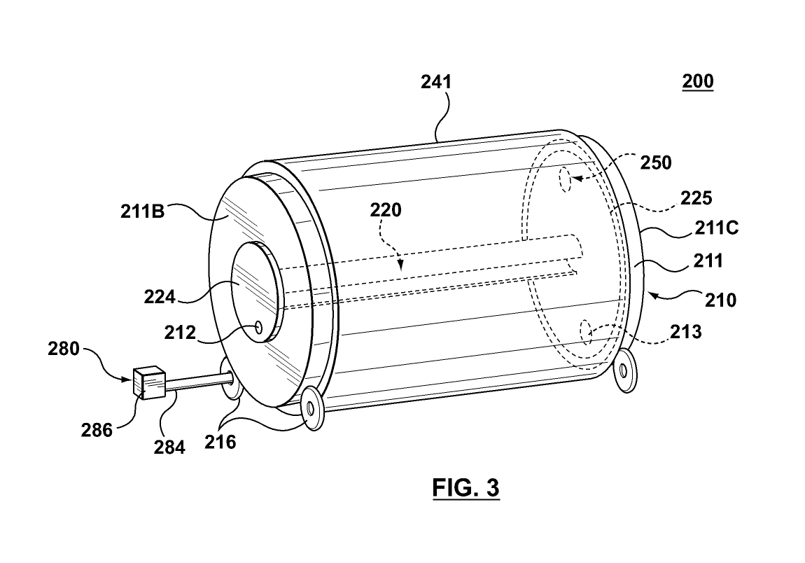

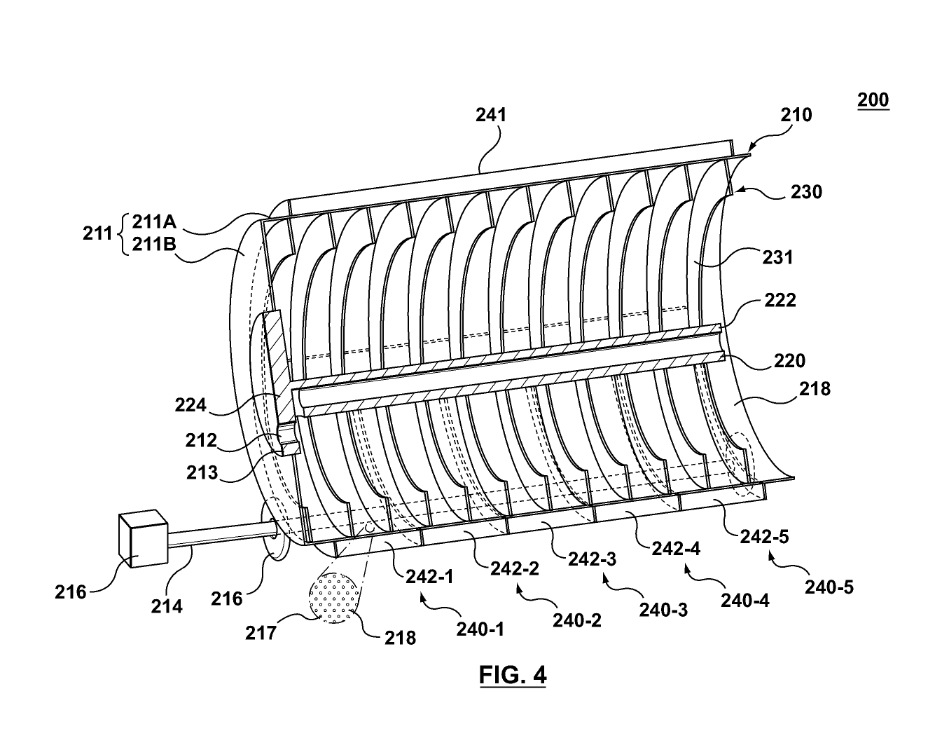

With reference to FIGS. 3 and 4, there is depicted a second non-limiting embodiment of a polymer treatment device 200 for providing a treatment, in use, to a polymer bed (not shown) having granules (not shown) of a polymer that are in a solid-state. The polymer treatment device 200 is similar to the polymer treatment device 100 (FIG. 2) and as such includes, amongst other things, a polymer supporter 210 with which to support, in use, the polymer bed, a radiant heater 220 with which to heat, in use, the polymer bed, a first fluid dispenser 240-1 with which to dispense, in use, a first treatment fluid (not shown), and a first fluid vent 250 with which to vent, in use, the first treatment fluid, along with a diffusate from the polymer bed potentially entrained therewith. The first fluid dispenser 240-1 and the first fluid vent 250 being arranged to promote, in use, a flow of the first treatment fluid through the polymer bed in between the granules thereof.

More particularly, the first fluid dispenser 240-1 and the first fluid vent 250-1 are positioned to be beneath and above the polymer bed, respectively, in use, such that the first treatment fluid may flow, in use, through the polymer bed.

More particularly, the polymer supporter 210 may be provided by a drum 211 that is rotatable about a centerline thereof. The drum 211 includes a cylindrical portion 211A having capped ends 211B and 211C. The drum 211 may be rotatably supported on a set of rollers 216, and wherein one or more of the set of rollers 216 is furthermore connected to a drive 286, by a drive shaft 284, for a rotation thereof, in use, and with it the drum 211. The polymer bed may be supported, in use, on a polymer support surface 218 that is an inner surface of the drum 211. The polymer treatment device 200 may further include a polymer guide 230 that is structured to guide, in use, the polymer bed along a polymer flow path within the polymer supporter 210 with rotation of the drum 211. The polymer guide 230 includes a helical vane that is connected to the polymer support surface 218 that serves to act as an Archimedes screw with rotation of the drum 211. In operation, the granules enter and exit the polymer supporter 210 through an inlet 212 and an outlet 213, respectively. The inlet 212 and the outlet 213 are defined through a first end wall 224 and a second end wall 225, respectively, that are disposed adjacent to the capped ends 211B and 211C. The first end wall 224 and a second end wall 225 may be arranged to remain stationary relative to the drum 211.

The radiant heater 220 may be suspended from a frame 222 that is arranged to extend between the first end wall 224 and the second end wall 225 within the drum 211. The radiant heater 220 may be furthermore arranged such as to be able to expose the uppermost granules in the polymer bed to radiant energy for sake of a direct heating thereof. Typically, the radiant heater 220 in such a device may be operable to emit energy having an infrared wavelength although other wavelengths are possible.

The polymer treatment device 200 may further include an enclosure 241 surrounding the cylindrical portion 211A of the drum 211, and wherein the enclosure 241 may be fixed from rotation with the drum 211 and thus the drum 211 is rotatable relative thereto. A first manifold 242-1 may be defined between the enclosure 241 and the drum 211 around a lower portion of the drum 211. The first manifold 242-1 may be connectable to a source of the first treatment fluid via a port (not shown) that may be defined through the enclosure 241. Also in support of the first fluid dispenser, the cylindrical portion 211A of the drum 211 includes perforations 217 defined therethrough. The size of the perforations 217 may be selected to be smaller than the granules and yet still allow for a passing, in use, of the first treatment fluid therethough. Thus, in the present non-limiting embodiment the first fluid dispenser 240-1 may be considered to be provided by the first manifold 242-1 and the perforations 217. Likewise, a second fluid dispenser 240-2, a third fluid dispenser 240-3, a fourth fluid dispenser 240-4, and a fifth fluid dispenser 240-5 may be similarly provided by a second manifold 242-2, a third manifold 242-3, a fourth manifold 242-4, and a fifth manifold 242-5, respectively, that are similarly defined between the enclosure 241 and the drum 211. The first fluid vent 250 may be defined in the second end wall 225. In an alternative non-limiting embodiment (not shown), the foregoing arrangement may be reversed, at least in part, wherein the first fluid vent may be associated with one or more of the first manifold 242-1, the second manifold 242-2, the third manifold 242-3, the fourth manifold 242-4, and the fifth manifold 242-5, and wherein the first fluid dispenser may be defined through the second end wall 225. In operation, the first treatment fluid, a second treatment fluid (not shown), a third treatment fluid (not shown), a fourth treatment fluid (not shown), and a fifth treatment fluid (not shown), pass from the first manifold 242-1, the second manifold 242-2, the third manifold 242-3, the fourth manifold 242-3, the fourth manifold 242-4, and the fifth manifold 242-5, respectively, through the perforations 217, as they sweep therepast with rotation of the drum 211, and thereafter into the polymer bed. The first treatment fluid, the second treatment fluid, the third treatment fluid, the fourth treatment fluid, and the fifth treatment fluid having entered through a bottom of the polymer bed will then flow therethrough in between the granules thereof to thereafter exit through a top of the polymer bed whereafter they may be vented, along with any diffusate from granules that may be entrained therewith, through the first fluid vent 250 (i.e. common vent).

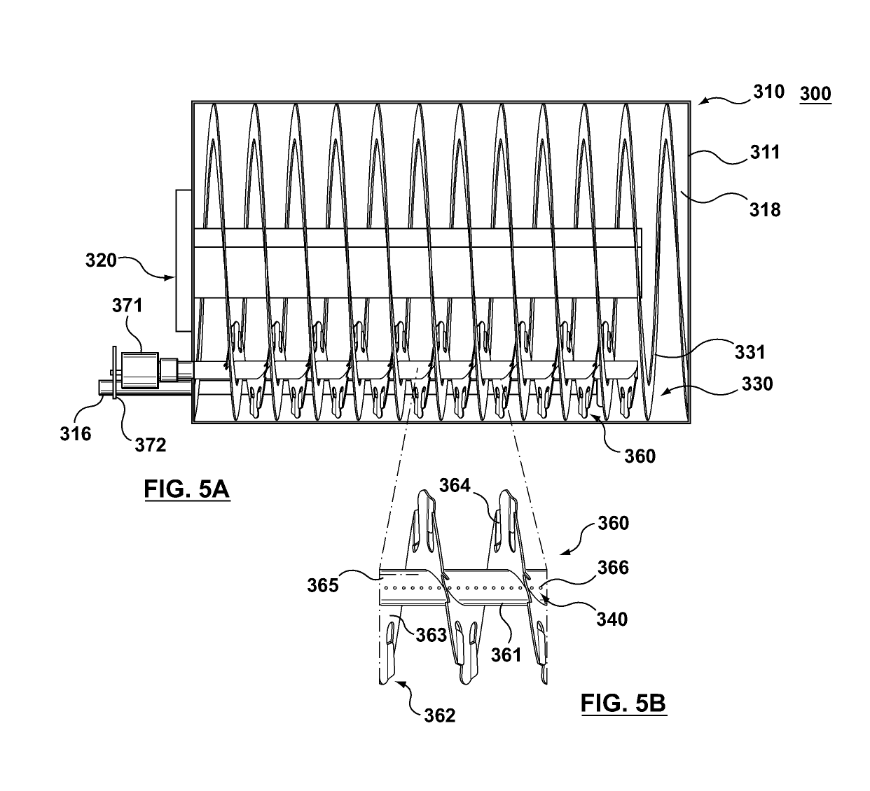

With reference to FIGS. 5A and 5B, there is depicted a third non-limiting embodiment of a polymer treatment device 300 for providing a treatment, in use, to a polymer bed (not shown) having granules (not shown) of a polymer that are in a solid-state. The polymer treatment device 300 is similar to the polymer treatment device 200 (FIGS. 3 and 4) and as such includes, amongst other things, a polymer supporter 310 with which to support, in use, the polymer bed, a radiant heater 320 with which to heat, in use, the polymer bed, a first fluid dispenser 340 with which to dispense, in use, a first treatment fluid (not shown), and a first fluid vent (not shown) with which to vent, in use, the first treatment fluid, along with a diffusate from the polymer bed potentially entrained therewith. The first fluid dispenser 340 and the first fluid vent being arranged to promote, in use, a flow of the first treatment fluid through the polymer bed in between the granules thereof. More particularly, the first fluid dispenser 340 and the first fluid vent (not shown) are positioned to be within and above the polymer bed, respectively, in use, such that the first treatment fluid may flow, in use, through the polymer bed.

More particularly, polymer supporter 310 may be provided by a drum 311 that is rotatable about a centerline thereof. The drum 311 may be rotatably supported on a set of rollers 316, and wherein one or more of the set of rollers 316 is furthermore connected to a drive (not shown) for a rotation thereof, in use, and with it the drum 311. The polymer bed is supported, in use, on a polymer support surface 318 that is an inner surface of the drum 311. The polymer treatment device 300 may further include a polymer guide 330 with which to guide, in use, the polymer bed along a polymer flow path within the polymer supporter 310 with rotation of the drum 311. The polymer guide 330 may be structured and arranged similarly to the polymer guide 230 (FIG. 3) of the polymer treatment device 200.

The radiant heater 320 may be structured and arranged within the drum 311 in a similar manner as the radiant heater 220 (FIG. 3) of the polymer treatment device 200.

The polymer treatment device 300 may further include an agitator 360 that is operable, in use, to further agitate the polymer bed. A technical effect of the foregoing may include a more homogenous heating of the polymer bed as the agitation (in this case a turning over of the polymer bed) promotes, in use, the regular direct exposure of the granules to the energy being emitted, in use, by the radiant heater 320. Another technical effect of the foregoing may include the ability to further control the rate at which the polymer bed is transported along the polymer flow path. The agitator 360 includes, amongst other things, a shaft 361 having a mixer element 362 depending therefrom, the agitator 360 being rotatable about a centerline of the shaft 361. In the present non-limiting embodiment the mixer element 362 may be a screw flight 363 that meshes with the vane 331 of the polymer guide 330. The helical forms defined by the screw flight 363 and the vane 331 have the same pitch angle but extend in opposite directions (i.e. helix are counter to each other). The screw flight 363 may further include a plurality of deflectors 364 outwardly depending therefrom. The deflectors 364 function, in use, to further agitate the granules of polymer bed. The agitator 360 and the drum 311 may be rotationally linked, for example, through a belt linkage 372 and a transmission 371 for synchronous counter-rotation thereof, in use, for sake of avoiding any interference between the agitator 360 and the vane 331.

In another non-limiting embodiment (not shown), the agitator 360 may be rotationally driven by other means, such as, a direct drive that is controllably linked for synchronous rotation with the drum. In another non-limiting embodiment (not shown), the helical forms defined by the screw flight 363 and the vane 331 may have the same pitch angle and extend in the same direction in which case the screw flight 363 and the vane 331 would be linked for synchronous co-rotation thereof. In yet another non-limiting embodiment (not shown), either of the foregoing non-limiting embodiments may be further modified wherein the screw flight 363 and the vane 331 may have a different pitch angle that requires their operation at different angular velocities—which may be accommodated by the transmission 371.

The first fluid dispenser 340 may be associated with the agitator 360. More particularly, the first fluid dispenser 340 may include a manifold 365 that is defined within the shaft 361, and a fluid channel 366, or more particularly a plurality thereof, may be defined through a side wall of the shaft 361. In operation, the first treatment fluid passes from the manifold 365 through the fluid channel 366 and into the polymer bed (not shown). Upon exiting the polymer bed the first treatment fluid is vented through a first fluid vent (not shown) that may be structured and otherwise arranged similarly to the first fluid vent 250 shown in FIG. 3. In an alternative non-limiting embodiment (not shown), the first fluid vent may be similarly associated with the agitator 360 in place of, or in addition to, the first fluid dispenser 340. In another alternative non-limiting embodiment (not shown), the fluid channel 366, may be associated with the mixer element 362—such as through the screw flight 363 and/or the deflectors 364.

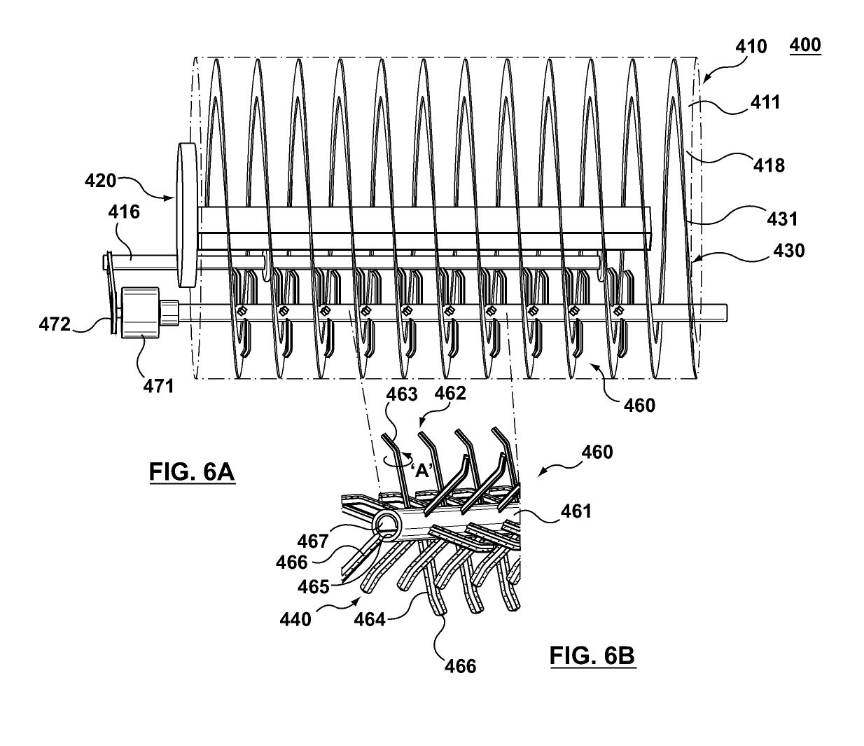

With reference to FIGS. 6A and 6B, there is depicted a fourth non-limiting embodiment of a polymer treatment device 400 for providing a treatment, in use, to a polymer bed (not shown) having granules (not shown) of a polymer that are in a solid-state. The polymer treatment device 400 is similar to the polymer treatment device 300 (FIG. 5A and 5B) and as such includes, amongst other things, a polymer supporter 410 with which to support, in use, the polymer bed, a radiant heater 420 with which to heat, in use, the polymer bed, a first fluid dispenser 440 with which to dispense, in use, a first treatment fluid (not shown), and a first fluid vent (not shown) with which to vent, in use, the first treatment fluid, along with a diffusate from the polymer bed potentially entrained therewith. The first fluid dispenser 440 and the first fluid vent being arranged to promote, in use, a flow of the first treatment fluid through the polymer bed in between the granules thereof. More particularly, the first fluid dispenser 440 and the first fluid vent (not shown) are positioned to be within and above the polymer bed, respectively, in use, such that the first treatment fluid may flow, in use, through the polymer bed.

The polymer supporter 410 may be structured and arranged similarly to the polymer supporter 310 (FIG. 5A) of the polymer treatment device 300 and as such includes a drum 411 that is rotatable about a centerline thereof. As such, the drum 411 may be rotatably supported on a set of rollers 416, and wherein one or more of the set of rollers 416 is furthermore connected to a drive (not shown) for a rotation thereof, in use, and with it the drum 411. The polymer bed may be supported, in use, on a polymer support surface 418 that is an inner surface of the drum 411. The polymer treatment device 400 may further include a polymer guide 430 with which to guide, in use, the polymer bed along a polymer flow path within the polymer supporter 410 with rotation of the drum 411. The polymer guide 430 may be structured and arranged similarly to the polymer guide 230 (FIG. 3) of the polymer treatment device 200.

The radiant heater 420 may be structured and arranged within the drum 411 in a similar manner as the radiant heater 220 (FIG. 3) of the polymer treatment device 200.

The polymer treatment device 400 may further include an agitator 460 that is operable, in use, to agitate the polymer bed. The agitator 460 may be structured and arranged similarly to the agitator 360 (FIG. 5A, 5B) of the polymer treatment device 300. The agitator 460 includes, amongst other things, a shaft 461 having a mixer element 462 depending therefrom, the agitator 460 being rotatable about a centerline of the shaft 461. In the present non-limiting embodiment the mixer element 462 may include a rake having a plurality of pins 463 that are arranged to depend in a helical array along an outer surface of the shaft 461 that mesh, in use, with the vane 431 of the polymer guide 430. The plurality of pins 463 may furthermore be adjustably mounted to the shaft 461, such as for rotational adjustment ‘A’. Each of the plurality of pins 463 may include a tubular member that may furthermore include a bent end that functions, in use, to assist with raking of the polymer bed (not shown). Each of the plurality of pins 463 may also include a pair of deflectors 464 outwardly depending therefrom, in the form of fins, that function, in use, to further agitate the granules of polymer bed. The agitator 460 and the drum 411 are rotationally linked through a belt linkage 472 and a transmission 471 for synchronous rotation thereof, in use, for sake of avoiding any interference between the mixer element 462 and the vane 431. The first fluid dispenser 440 may also be associated with the agitator 460. More particularly, the first fluid dispenser 440 may include a manifold 465 that is defined within the shaft 461, and a fluid channel 466 that extends through one or more of the plurality of pins 463. More particularly, each of the plurality of pins 463 includes a plurality of the fluid channels 466 having outlets arranged along the pair of deflectors 464. The first fluid dispenser 440 may further include a valve member 467 that is non-rotatably arranged in the manifold. In operation, the first treatment fluid passes from the manifold 465 through the fluid channel 466 and into the polymer bed (not shown). Moreover, the valve member 467 and the manifold 465 cooperate, in use, to selectively connect the fluid channel 466 with the manifold 465 responsive to a rotation of the agitator 460 and in this way only the subset of the plurality of pins 463 that are immersed in the polymer bed are connected to a source of the first treatment fluid, via the manifold 465.

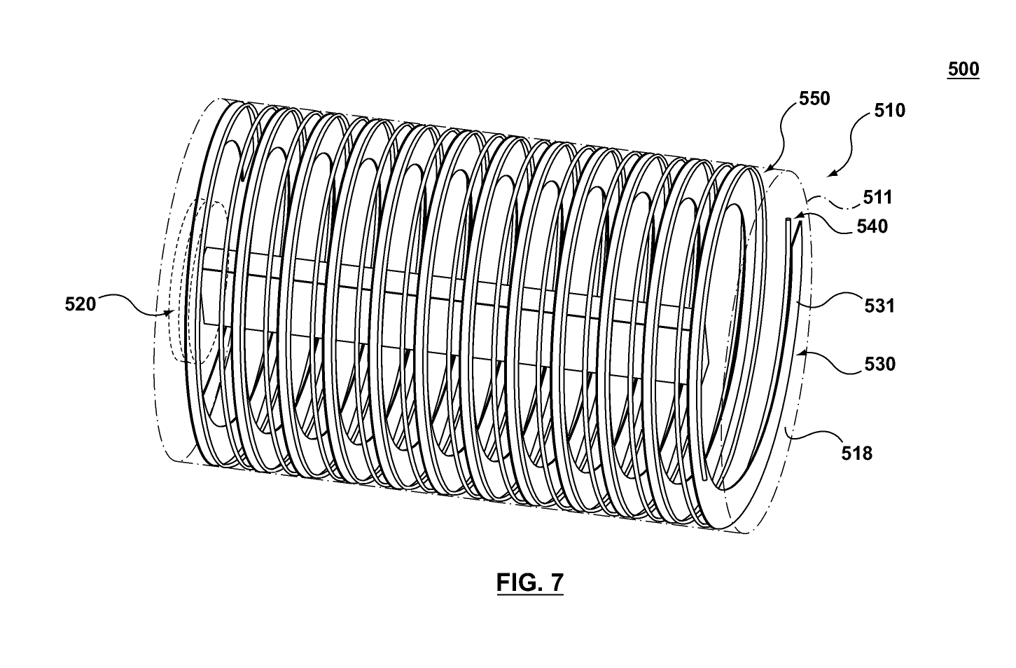

With reference to FIG. 7, there is depicted a fifth non-limiting embodiment of a polymer treatment device 500 for providing a treatment, in use, to a polymer bed (not shown) having granules (not shown) of a polymer that are in a solid-state. The polymer treatment device 500 is similar to the polymer treatment device 300 (FIG. 5A and 5B) and as such includes, amongst other things, a polymer supporter 510 with which to support, in use, the polymer bed, a radiant heater 520 with which to heat, in use, the polymer bed, a first fluid dispenser 540 with which to dispense, in use, a first treatment fluid (not shown), and a first fluid vent 550 with which to vent, in use, the first treatment fluid, along with a diffusate from the polymer bed potentially entrained therewith. The first fluid dispenser 540 and the first fluid vent 550 being arranged to promote, in use, a flow of the first treatment fluid through the polymer bed in between the granules thereof. More particularly, the first fluid dispenser 540 and the first fluid vent (not shown) are both positioned to be within the polymer bed, in use, such that the first treatment fluid may flow, in use, through the polymer bed. The first fluid dispenser 540 may be positioned upstream or downstream of the first fluid vent. Positioning the first fluid dispenser 540 downstream of the first fluid vent may improve the treatment efficiency.

The polymer supporter 510 may be structured and arranged similarly to the polymer supporter 310 (FIG. 5A) of the polymer treatment device 300 and as such includes, amongst other things, a drum 511 that is rotatable about a centerline thereof. The polymer bed may be supported, in use, on a polymer support surface 518 that is an inner surface of the drum 511. The polymer treatment device 500 may further include a polymer guide 530 with which to guide, in use, the polymer bed along a polymer flow path within the polymer supporter 510 with rotation of the drum 511. The polymer guide 530 may be structured and arranged similarly to the polymer guide 230 (FIG. 3) of the polymer treatment device 200.

The radiant heater 520 may be structured and arranged within the drum 511 in a similar manner as the radiant heater 220 (FIG. 3) of the polymer treatment device 200.

The first fluid dispenser 540 and the first fluid vent 550 are each provided by a porous hose that is wound around the polymer support surface 518 of the drum 511. The porous hose of the first fluid dispenser 540 and the first fluid vent 550 are each connectable, in use, to a source and sink, respectively, for the first treatment fluid. In this arrangement, portions of both the first fluid dispenser 540 and the first fluid vent 550 are arranged so as to be immersed, in use, within the polymer bed (not shown), whereby a flow of the first treatment fluid (not shown) is promoted through the polymer bed in between the granules (not shown) thereof.

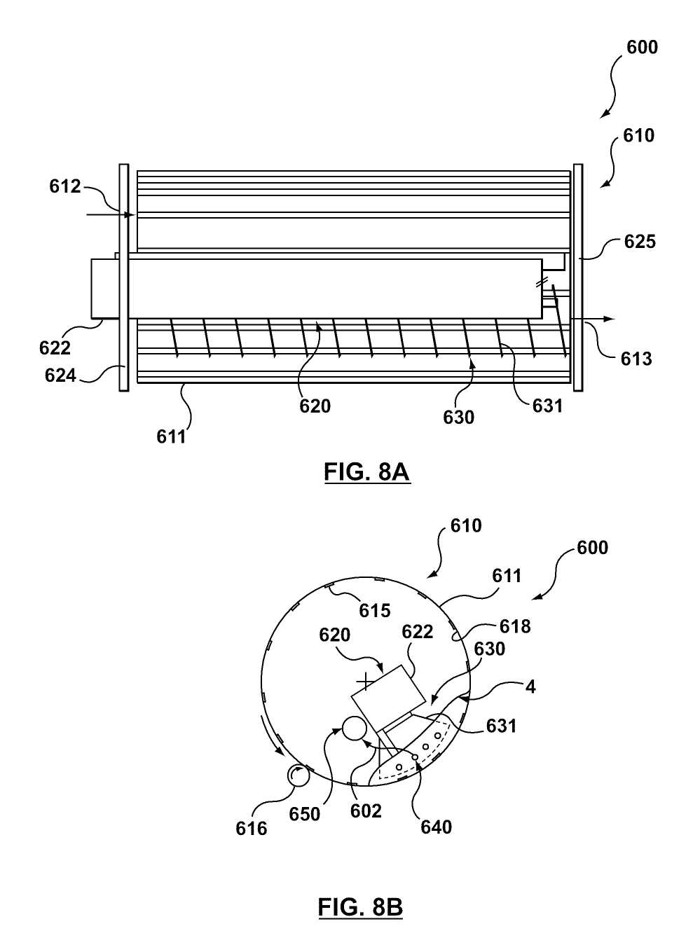

With reference to FIGS. 8A and 8B, there is depicted a sixth non-limiting embodiment of a polymer treatment device 600 for providing a treatment, in use, to a polymer bed 4 having granules (not shown) of a polymer that are in a solid-state. The polymer treatment device 600 is similar to the polymer treatment device 300 (FIG. 5A and 5B) and as such includes, amongst other things, a polymer supporter 610 with which to support, in use, the polymer bed 4, a radiant heater 620 with which to heat, in use, the polymer bed 4, a first fluid dispenser 640 with which to dispense, in use, a first treatment fluid 602, and a first fluid vent 650 with which to vent, in use, the first treatment fluid, along with a diffusate from the polymer bed 4 potentially entrained therewith. The first fluid dispenser 640 and the first fluid vent 650 being arranged to promote, in use, a flow of the first treatment fluid through the polymer bed 4 in between the granules thereof. More particularly, the first fluid dispenser 640 and the first fluid vent 650 are positioned to be within and above the polymer bed, respectively, in use, such that the first treatment fluid 602 may flow, in use, through the polymer bed 4.

The polymer supporter 610 may be structured and arranged similarly to the polymer supporter 310 (FIG. 5A) of the polymer treatment device 300 and as such includes a drum 611 that is rotatable about a centerline thereof on a roller 616. An inlet 612 and the outlet 613 are defined through a first end wall 624 and a second end wall 625, respectively, that are non-rotatably disposed adjacent to opposite ends of the drum 611. The polymer bed 4 may be supported, in use, on a polymer support surface 618 that is an inner surface of the drum 611. One or more protuberances 615 may furthermore be connected to the polymer support surface 618 that may assist, in use, with turning over of the polymer bed 4 with rotation of the drum 611. In an alternative non-limiting embodiment (not shown), the protuberances 615 may include physical bumps such as bolt heads, tangs of metal. Further alternatives may include grooves or roughening of the drum surface like knurling, shot peening, sand blasting, hammered etc. Whereas the drum 611 may have been depicted as having a cylindrical shape, it may have other forms including, for example, a multi-sided prism.

The radiant heater 620 may be structured and arranged within the drum 611 in a similar manner as the radiant heater 220 (FIG. 3) of the polymer treatment device 200. More particularly, the radiant heater 620 is arranged within the drum 611 on a frame 622 in a manner such that the radiant heater 620 is able to directly expose the uppermost granules (not shown) in the polymer bed 4 to radiant energy for sake of a heating thereof.

The polymer treatment device 600 may further include a polymer guide 630 with which to guide, in use, the polymer bed along a polymer flow path within the polymer supporter 610 with rotation of the drum 611. The polymer guide 630 may include a vane 631, or more particularly a plurality thereof, that are adjustably connected to the frame 622 that supports the radiant heater 620 within the drum 611. The first fluid dispenser 640 may furthermore be defined by the polymer guide 630, wherein the first fluid dispenser 640 is arranged thereon to be immersed, in use, within the polymer bed 4. In operation, the first treatment fluid 602 is dispensed within the polymer bed 4 whereafter it flows through the polymer bed 4 in between the granules (not shown) thereof, whereafter the first treatment fluid 602 exits the polymer bed 4 through the first fluid vent 650. The granules (not shown) that make up the polymer bed 4 enter and exit the polymer supporter 610 through the inlet 612 and the outlet 613, respectively, and the polymer bed 4 is furthermore transported through the polymer supporter 610, along the polymer flow path, with rotation of the drum 611 that serves to push the polymer bed 4 along the polymer guide 630. Furthermore, adjusting one or more of the vanes 631 (separately or in groups), such as, for example, an angle of attack thereof relative to an axis of the drum 611, may furthermore permit a rate flow adjustment of the polymer bed 4 through the polymer supporter 610.

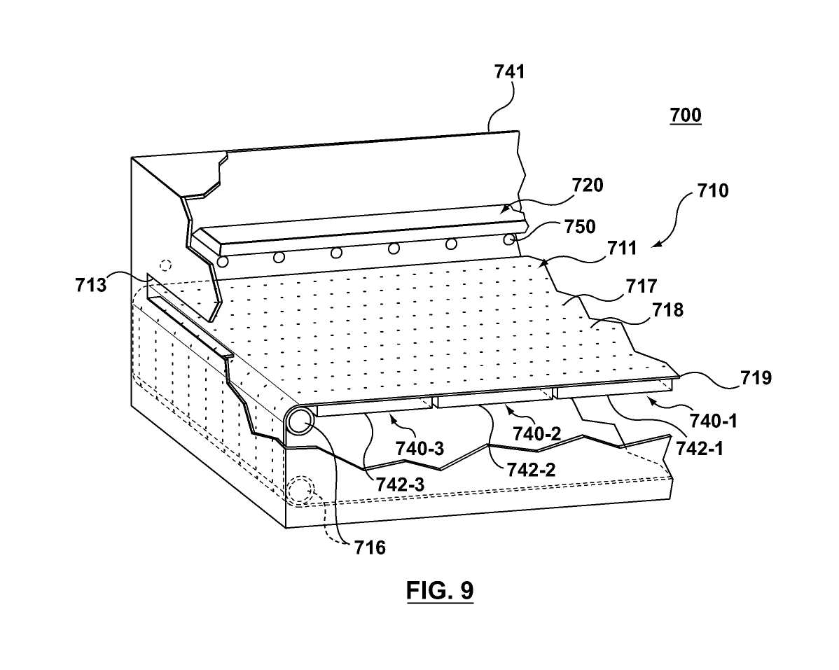

With reference to FIG. 9, there is depicted a seventh non-limiting embodiment of a polymer treatment device 700 for providing a treatment, in use, to a polymer bed (not shown) having granules (not shown) of a polymer that are in a solid-state. The polymer treatment device 700 includes, amongst other things, a polymer supporter 710 with which to support, in use, the polymer bed (not shown), a radiant heater 720 with which to heat, in use, the polymer bed, a first fluid dispenser 740-1 with which to dispense, in use, a first treatment fluid (not shown), and a first fluid vent 750 with which to vent, in use, the first treatment fluid, along with a diffusate from the polymer bed potentially entrained therewith. The first fluid dispenser 740-1 and the first fluid vent 750 being arranged to promote, in use, a flow of the first treatment fluid through the polymer bed in between the granules thereof. More particularly, the first fluid dispenser 740-1 and the first fluid vent 750 are positioned to be beneath and above the polymer bed, respectively, in use, such that the first treatment fluid may flow, in use, through the polymer bed.

The polymer supporter 710 may be structured and arranged as a conveyor 711 having a portion that is arranged within, or otherwise surrounded by, an enclosure 741. The conveyor 711 may be structured as a belt-type conveyor having a recirculatable belt 719 that is carried on rollers 716, and wherein a polymer support surface 718 is provided on the recirculatable belt 719 upon which is supported, in use, the polymer bed. An inlet (not shown) and the outlet 713 are defined through opposite ends of the enclosure 741 through which, in use, the granules of the polymer bed may be passed.

The radiant heater 720 may be structured and arranged within the enclosure 741. The radiant heater 720 may be arranged to directly expose, in use, the granules in the polymer bed to radiant energy for sake of a heating thereof, and as such the radiant heater 720 may be arranged, as shown, above the polymer support surface 718.

The first fluid dispenser 740-1 includes a manifold 742-1 that is arranged directly beneath the recirculatable belt 719 to channel, in use, the first treatment fluid (not shown) through perforations 717 that are defined through the recirculatable belt 719. The size of the perforations 717 may be selected to be smaller than the granules and yet still allow for a passing, in use, of the first treatment fluid therethough. The polymer treatment device 700 may further include additional fluid dispensers, including, as shown, a second fluid dispenser 740-2 and a third fluid dispenser 740-3 that are configured to be structurally and operationally similar to the first fluid dispenser 740-1. The first fluid vent 750 may furthermore be defined as an opening that passes through a sidewall of the enclosure 741 in a location that is above, in use, an upper surface of the polymer bed (not shown). In operation, the first treatment fluid (not shown), a second treatment fluid (not shown), and a third treatment fluid (not shown), pass from the first manifold 742-1, the second manifold 742-2, and the third manifold 742-3, respectively, through the perforations 717, as they slide therepast with recirculation, in use, of the recirculatable belt 719, and thereafter into the polymer bed. The first treatment fluid, the second treatment fluid, and the third treatment fluid having entered through a bottom of the polymer bed will then flow therethrough in between the granules thereof to thereafter exit through a top of the polymer bed whereafter they may be vented, along with any diffusate from granules that may be entrained therewith, through the first fluid vent 750 and others like it. In an alternative non-limiting embodiment (not shown), the foregoing embodiment may be reversed in that the first fluid vent 750 may be associated with one or more of the first manifold 742-1, the second manifold 742-2, and the third manifold 742-3, and wherein the first fluid dispenser 740-1 may be defined through the enclosure 741.

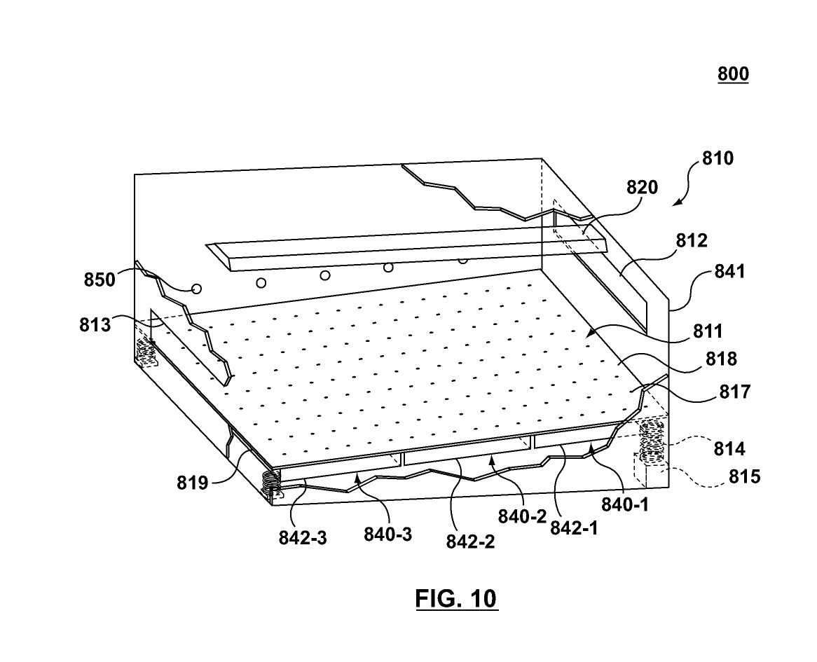

With reference to FIG. 10, there is depicted an eighth non-limiting embodiment of a polymer treatment device 800 for providing a treatment, in use, to a polymer bed (not shown) having granules (not shown) of a polymer that are in a solid-state. The polymer treatment device 800 is similar to the polymer treatment device 700 (FIG. 9) and as such includes, amongst other things, a polymer supporter 810 with which to support, in use, the polymer bed (not shown), a radiant heater 820 with which to heat, in use, the polymer bed, a first fluid dispenser 840-1 with which to dispense, in use, a first treatment fluid (not shown), and a first fluid vent 850 with which to vent, in use, the first treatment fluid, along with a diffusate from the polymer bed potentially entrained therewith. The first fluid dispenser 840-1 and the first fluid vent 850 being arranged to promote, in use, a flow of the first treatment fluid through the polymer bed in between the granules thereof. More particularly, the first fluid dispenser 840-1 and the first fluid vent 850 are positioned to be beneath and above the polymer bed, respectively, in use, such that the first treatment fluid may flow, in use, through the polymer bed.

The polymer supporter 810 may be structured and arranged similarly to the polymer supporter 710 (FIG. 9) of the polymer treatment device 700 and as such includes, amongst other things, a conveyor 811 having a portion that is arranged within, or otherwise surrounded by, an enclosure 841. The conveyor 811 may be structured as a vibratory-type conveyor having a table 819 that is carried on vibratory mounts 814, one of which is associated with an vibratory oscillator 815. A polymer support surface 818 is provided on the table 819 upon which is supported, in use, the polymer bed. An inlet 812 and the outlet 813 are defined through opposite ends of the enclosure 841 through which, in use, the granules of the polymer bed may be passed. Furthermore, a material feed rate through the polymer supporter 810 may be controlled by varying the frequency of oscillation and/or an elevation of the table 819.

The radiant heater 820 may be structured and arranged within the enclosure 841 in a similar manner as the radiant heater 720 (FIG. 9) of the polymer treatment device 700.

The first fluid dispenser 840-1 may be structured and arranged in a similar manner as the first fluid dispenser 740-1 (FIG. 9) of the polymer treatment device 700. More particularly, the first fluid dispenser 840-1 includes a manifold 842-1 that is arranged directly beneath the table 819 to channel, in use, the first treatment fluid (not shown) through perforations 817 that are defined through the table 819. The polymer treatment device 800 may further include additional fluid dispensers, including, as shown, a second fluid dispenser 840-2 and a third fluid dispenser 840-3 that are configured to be structurally and operationally similar to the first fluid dispenser 840-1. The first fluid vent 850 may furthermore be defined as an opening that passes through a sidewall of the enclosure 841 in a location that is above, in use, an upper surface of the polymer bed (not shown). In operation, the first treatment fluid (not shown), a second treatment fluid (not shown), and a third treatment fluid (not shown), pass from the first manifold 842-1, the second manifold 842-2, and the third manifold 842-3, respectively, through the perforations 817 of the table 819 and thereafter into the polymer bed. The first treatment fluid, the second treatment fluid, and the third treatment fluid having entered through a bottom of the polymer bed will then flow therethrough in between the granules thereof to thereafter exit through a top of the polymer bed whereafter they may be vented, along with any diffusate from granules that may be entrained therewith, through the first fluid vent 850 and others like it.

In another alternative non-limiting embodiment (not shown), the first fluid dispenser may further be associated with directionally adjustable gas jets that are disposed within the polymer bed.

In yet another alternative non-limiting embodiment (not shown) the polymer treatment device 100, 200, 300, 400, 500, 600, 700, 800 may be further structured to re-circulate the granules of the polymer bed therethrough for two or more passes, wherein for recirculation the granules are to be passed from the outlet to the inlet of the polymer supporter 110, 210, 310, 410, 510, 610, 710, 810. The re-circulation from the outlet to the inlet may be accomplished with a re-circulation structure such as, for example, a vacuum loader (not shown). With the foregoing, it is further possible that the operational parameters associated with the polymer treatment device 100, 200, 300, 400, 500, 600, 700, 800, such as, for example, the type/quality/temperature of the treatment fluid, may be maintained or varied from pass to pass of the granules therethrough. For example, the operational parameters associated with the polymer treatment device 100, 200, 300, 400, 500, 600, 700, 800 may be such that the granules in the polymer bed are subjected to a first treatment such as, for example, polymer crystallization and wherein the granules are re-circulated through the polymer treatment device until the desired crystallinity is achieved. Thereafter, the granules may be removed from the polymer treatment device 100, 200, 300, 400, 500, 600, 700, 800 or otherwise re-circulated once again whilst being subjected to a further treatment such as, for example, a solid-state polymerization thereof that may involve different operational parameters.

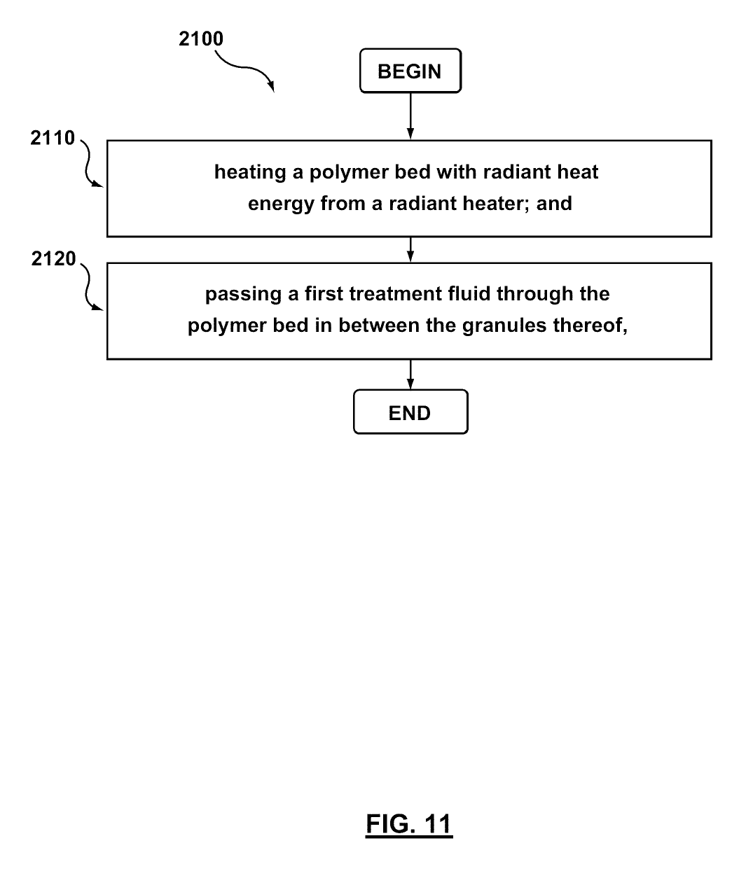

Reference will now be made to FIGS. 2 and 11 which depict the structure and steps, respectively, that are associated with a non-limiting embodiment of a method 2100 for providing a treatment to a polymer bed 4 within a polymer treatment device 100, the polymer bed 4 having granules 2 of a polymer that are in a solid-state. Moreover, a computer-readable medium (not shown) having computer-executable instructions which, when executed by the controller result in the polymer treatment device 100 being operable to execute the method 2100. The method 2100 may alternately be implemented for operating the other non-limiting embodiments of the polymer treatment device 200, 300, 400, 500, 600, and 700.

STEP 2110:

The method 2100 starts with heating of the polymer bed 4 with radiant heat energy from the radiant heater 120. The foregoing may involve a direct exposure of the polymer bed 4 to radiation from the radiant heater 120 whereby energy is absorbed throughout portions of sections of the granules 2 which raises, in use, the temperature thereof. A technical effect of raising the internal temperature of the granule may include the release, for example, of diffu sate such as absorbed water and volatiles (e.g. polymer products, contaminants, etc.).

STEP 2120:

Lastly, the method 2100 includes passing the first treatment fluid 102-1 through the polymer bed 4 in between the granules 2 thereof, as opposed to, or in addition to, merely passing it over the polymer bed 4 as was the practice in the prior art. The passing of the first treatment fluid 102-1 includes dispensing the first treatment fluid 102-1 from the first fluid dispenser 140-1 and then venting the first treatment fluid 102-1, along with a diffusate from the polymer bed 4 potentially entrained therewith, through a first fluid vent 150-1. Such that the first treatment fluid 102-1 may be effectively passed through the polymer bed 4 the first fluid dispenser 140-1 and the first fluid vent 150-1 may be arranged such that the polymer bed 4 is disposed, in use, therebetween.

The heating 2110 and the passing 2120 may be controlled such that one or more treatments are provided to the granules 2 including, without specific limitation, one or more of drying of the granules 2, crystallizing of the granules 2, boosting an intrinsic viscosity of the granules 2, reducing the intrinsic viscosity of the granules 2 in the polymer bed 4, and otherwise decontaminating of the granules 2 (e.g. decontaminate to food grade levels of contaminants). Decontamination may include the removal of volatiles (i.e. as a component of the diffusate) such as acetaldehyde, caffeine, ethylene glycol, limonene, toluene, oligomers, and absorbed contaminants, as well as reactants that may shift the equilibrium balance of chemical reaction associated with solid-state polymerization including ethylene glycol and water. To provide the optimal conditions to accomplish any one of the foregoing treatments, and others, the method 2100 may further include the step of conditioning the first treatment fluid 102-1 before it is dispensed by the first into the polymer bed 4. The step of conditioning the first treatment fluid 102-1 may include operating a first conditioning apparatus 243-1 to perform one or more of heating the first treatment fluid 102-1, cooling the first treatment fluid 102-1, dehumidifying the first treatment fluid 102-1, and/or humidifying of the first treatment fluid 102-1.

The various treatments that may be provided to the granules 2 in the polymer bed 4 may be simple or complex in that they may involve one or more discrete stages of treatment. Accordingly, the steps of heating 2110 and passing 2120 may be performed within one or more of a succession of polymer-treatment zones z1, z2, z3, z4 that are defined along a polymer flow path within the polymer treatment device 100—dependent on the steps involved in the overall treatment that is to be provided to the granules 2.

For example, many of the treatments that are to be provided to the granules 2 may include an initial step of crystallizing of the granules 2, at least in part. A technical effect of increasing the crystal content of the granules 2 is that it may allow for a subsequent step of one or more of drying, polymerization, and/or decontamination, to be performed at higher temperature and thus at a higher rate. To promote the crystallizing of the granules 2 the method 2100 may include humidifying the first treatment fluid 102-1, such as air, heating the granules 2 of the polymer bed 4 to a crystallization temperature of the polymer, while, or subsequently, passing 2120 of the conditioned first treatment fluid 102-1 through the polymer bed 4. The foregoing may be practiced within any one of the polymer-treatment zones z1, z2, z3, z4, such as, for example, within the first polymer-treatment zone z1 thereof.

The further treatment of the granules 2 may also involve a subsequent step of drying of the granules 2, at least in part, whereby absorbed water, and potentially volatiles, are driven therefrom. To promote the drying of the granules 2 the method 2100 may include dehumidifying a second treatment fluid 102-2, such as air, heating the granules 2 of the polymer bed 4 to a drying temperature of the polymer, while, or subsequently, passing 2120 of the conditioned second treatment fluid 102-2 through the polymer bed 4. The foregoing may be practiced within any one of the polymer-treatment zones z1, z2, z3, z4, such as, for example, within the second polymer-treatment zone z2 thereof.

The further treatment of the granules 2 may also involve a subsequent step of polymerization of the granules 2 in the polymer bed 4 to promote boosting of an intrinsic viscosity thereof (i.e. increased molecular weight). A technical effect of controlling the intrinsic viscosity of the granule 2 may include the ability to recover some of the intrinsic viscosity of granules 2 of a recycled polymer that may have been lost from a previous thermal history. To promote the polymerization of the granules 2 the method 2100 may include dehumidifying a third treatment fluid 102-3, such as air or an inert gas that may further have a polymerization reagent entrained therewith, to a level that promote the solid state polymerization, and heating the granules 2 of the polymer bed 4 to a solid-state polymerization temperature of the polymer, while, or subsequently, passing 2120 of the conditioned third treatment fluid 102-3 through the polymer bed 4. The foregoing may be practiced within any one of the polymer-treatment zones z1, z2, z3, z4, such as, for example, within the third polymer-treatment zone z3 thereof.

Instead of, or in addition to, the polymerization of the granules 2, the method 2100 may also involve a subsequent step of decontaminating of the granules 2 (i.e. further drive off volatiles from the granules 2). To promote the decontamination of the granules 2 the method 2100 may include drying of the third treatment fluid 102-3, such as air, heating the granules 2 of the polymer bed 4 to the drying temperature of the polymer, while, or subsequently, passing 2120 of the conditioned third treatment fluid 102-3 through the polymer bed 4. The foregoing may be practiced within any one of the polymer-treatment zones z1, z2, z3, z4, such as, for example, within the third polymer-treatment zone z3, and/or a fourth polymer-treatment zone z4 thereof.

In accordance with an alternative non-limiting embodiment, the further treatment of the granules 2 may instead involve a subsequent step of polymer degradation of the granules 2 in the polymer bed 4 to promote reducing of an intrinsic viscosity thereof (i.e. decreased molecular weight). To promote the polymer degradation of the granules 2 the method 2100 may include humidifying the second treatment fluid 102-2, such as air, that may include a polymerization reagent, heating the granules 2 of the polymer bed 4 to a solid-state degradation temperature of the polymer, while, or subsequently, passing 2120 of the conditioned second treatment fluid 102-2 through the polymer bed 4 (i.e. hydrolytic degradation). The foregoing may be practiced within any one of the polymer-treatment zones z1, z2, z3, z4, such as, for example, within the second polymer-treatment zone z2 thereof.

The location (i.e. polymer-treatment zone) of each process function (i.e. crystallize, dry, solid-state polymerization) within the polymer treatment device 100 is not fixed, and will depend on the variables that are associated with the granules 2 of the polymer and the required process and interrelationships with process parameters to make the resin usable.

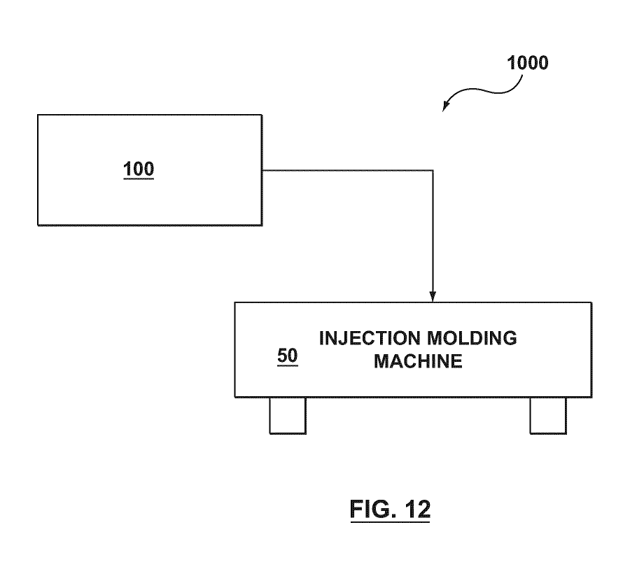

Reference will now be made to FIG. 12 which depicts a non-limiting embodiment of a molding system 1000 wherein the polymer treatment device 100 is connected to an injection molding machine 50 to provide treated granules (not shown) of a polymer thereto for further processing into a molded article (not shown). In this way, the granules of the polymer (i.e. molding material) upon entering the molding machine 50 may already be at an elevated temperature (a residual condition from having been treated in the polymer treatment device 100), whereby the amount of energy required to melt (by heating) and otherwise mold the molding material in the molding machine 50 is substantially reduced. In a non-limiting embodiment, the molded articles may be preforms of the type that are subsequently blow molded into bottles. The granules (not shown) of the polymer from which the preforms are molded may include, for example, PET, that is from one or more of virgin stock or post-consumer recycling.

Further to the technical effects mentioned previously, there may yet be further technical effects associated with one or more of the foregoing non-limiting embodiments of the polymer treatment device 100, 200, 300, 400, 500, 600, 700, 800 and the method 2100 for providing a treatment to a polymer bed 4. For example, the foregoing may make it possible to reduce a processing inventory of granules 2 of the polymer in comparison with traditional dryers. Also, the foregoing may make it possible to dynamically adjust the intrinsic viscosity of the granules 4 (including the ability to correct for recycled material that is out of specification). Furthermore, the foregoing may have a reduced footprint in comparison with traditional polymer treatment devices. Further still, there may be improved economics with a molding system having the foregoing polymer treatment device in association with a dedicated injection molding machine.

It is noted that the foregoing has outlined some of the more pertinent non-limiting embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed non-limiting embodiments can be effected without departing from the spirit and scope of the invention. The described non-limiting embodiments ought to be construed to be merely illustrative of some of the more prominent features and applications of the invention. Other beneficial results can be realized by applying the disclosed invention in a different manner or modifying the invention in ways known to those familiar with the art. This includes the mixing and matching of features, elements and/or functions between various non-limiting embodiments is expressly contemplated herein, unless described otherwise, above.

What is claimed is:

1. A polymer treatment device (100, 200, 300, 400, 500, 600, 700, 800) that provides, in use, a treatment to a polymer bed (4) having granules (2) of a polymer that are in a solid-state, comprising:
a polymer supporter (110, 210, 310, 410, 510, 610, 710, 810) with which to support, in use, the polymer bed (4);
a radiant heater (120, 220, 320, 420, 520, 620, 720, 820, 1020) with which to heat, in use, the polymer bed (4);
a first fluid dispenser (140-1, 240-1, 340, 440, 540, 640, 740-1, 840-1) with which to dispense, in use, a first treatment fluid (102-1);
a first fluid vent (150-1, 250, 550, 650, 750, 850) with which to vent, in use, the first treatment fluid (102-1), along with a diffusate from the polymer bed (4) potentially entrained therewith; and
the first fluid dispenser (140-1, 240-1, 340, 440, 540, 640, 740-1, 840-1) and the first fluid vent (150-1, 250, 550, 650, 750, 850) being arranged to promote a flow of the first treatment fluid (102-1) through the polymer bed (4) in between the granules (2) thereof.

2. The polymer treatment device (100) of claim 1, wherein:
the first fluid dispenser (140-1) is connectable to a first conditioning apparatus (143-1) that conditions, in use, the first treatment fluid (102-1) including one or more of: i) heating; ii) cooling;
iii) dehumidifying; and iv) humidifying thereof.

3. The polymer treatment device (100, 200, 300, 400, 500, 600, 700, 800) of claim 1, wherein:
the radiant heater (120, 220, 320, 420, 520, 620, 720, 820, 1020) is operable to emit energy having one of i) an infrared wavelength; and ii) a microwave wavelength.

4. The polymer treatment device (100, 200, 300, 400, 500, 600, 700, 800) of claim 1, wherein:
the polymer supporter (110, 210, 310, 410, 510, 610, 710, 810) being configured to transport the polymer bed (4) along a polymer flow path defined therethrough.

5. The polymer treatment device (100, 200, 300, 400, 500, 600, 700, 800) of claim 4, further comprising:
a re-circulation structure that is arranged to re-circulate the granules of the polymer bed from an outlet to an inlet of the polymer supporter (110, 210, 310, 410, 510, 610, 710, 810).

6. The polymer treatment device (100) of claim 4, wherein:
a succession of polymer-treatment zones (z1, z2, z3, z4) are defined along the polymer flow path;
the first fluid dispenser (140-1) is arranged in one of the succession of polymer-treatment zones (z1, z2, z3, z4); and
the polymer treatment device (100) further comprises a second fluid dispenser (140-2) to dispense, in use, a second treatment fluid (102-2);
the second fluid dispenser (140-2) being arranged within another one of the succession of polymer-treatment zones (z1, z2, z3, z4).

7. The polymer treatment device (100) of claim 6, wherein:
the first fluid vent (150-1) is arranged in the one of the succession of polymer-treatment zones (z1, z2, z3, z4) with the first fluid dispenser (140-1).

8. The polymer treatment device (100) of claim 6, further comprising:
a second fluid vent (150-2) that is arranged in the another one of the succession of polymer-treatment zones (z1, z2, z3, z4) with the second fluid dispenser (140-2);
the second fluid dispenser (140-2) and the second fluid vent (150-2) being arranged to promote the flow of the first treatment fluid (102-1) through the polymer bed (4) in between the granules (2) thereof.

9. The polymer treatment device (100, 200, 300, 400, 500, 600, 700, 800) of claim 1, wherein:
at least one of the first fluid dispenser (140-1, 240-1, 340, 440, 540, 640, 740-1, 840-1) and the first fluid vent (150-1, 250, 550, 650, 750, 850) is arranged so as to be immersed, in use, within the polymer bed (4).

10. The polymer treatment device (200, 300, 400, 500, 600) of claim 4, further comprising:
a polymer guide (230, 330, 430, 530, 630) that is arranged to guide, in use, the polymer bed (4) along the polymer flow path within the polymer supporter (210, 310, 410, 510, 610).

11. The polymer treatment device (600) of claim 10, wherein:
at least one of the first fluid dispenser (640) and the first fluid vent (650) being defined by the polymer guide (630).

12. The polymer treatment device (200, 300, 400, 500, 600) of claim 10, wherein:
the polymer supporter (210, 310, 410, 510, 610) includes a drum (211, 311, 411, 511, 611) that is rotatable about a centerline thereof;
the polymer bed (4) being supported, in use, on a polymer support surface (218, 318, 418, 518, 618) within the drum (211, 311, 411, 511, 611);
the polymer guide (230, 330, 430, 530, 630) includes a vane (231, 331, 431, 531, 631) that is arranged within the drum (211, 311, 411, 511, 611); and
the radiant heater (220, 320, 420, 520, 620) being arranged within the drum (211, 311, 411, 511, 611).

13. The polymer treatment device (200, 300, 400, 500, 600) of claim 12, wherein:
the vane (231, 331, 431, 531, 631) is connected to one of: i) the drum (211, 311, 411, 511, 611); or ii) a frame (622) that supports the radiant heater (120, 220, 320, 420, 520, 620, 720, 820, 1020) within the drum (211, 311, 411, 511, 611).

14. The polymer treatment device (500) of claim 12, wherein:
at least one of the first fluid dispenser (540) and the first fluid vent (550) includes a porous hose that is wound around the polymer support surface (518) of the drum (511).

15. The polymer treatment device (200) of claim 12, wherein:
the drum (211) includes a cylindrical portion (211A) having perforations (217) defined therethrough;
at least one of the first fluid dispenser (240-1) and the first fluid vent (250) includes:
an enclosure (241) surrounding the drum (211), and wherein the drum (211) is rotatable relative thereto; and
a first manifold (242-1) defined between the enclosure (241) and the drum (211) around a lower portion of the drum (211) to channel the first treatment fluid (102-1) through the perforations (217), as they sweep therepast.

16. The polymer treatment device (300, 400) of claim 1, further comprising:
an agitator (360, 460) to agitate the polymer bed (4).

17. The polymer treatment device (300, 400) of claim 16, wherein:
the agitator (360, 460) includes:
a shaft (361, 461); and
a mixer element (362, 462) depending from the shaft (361, 461);
the agitator (360, 460) being rotatable about a centerline of the shaft (361, 461).

18. The polymer treatment device (300) of claim 17, wherein:
the mixer element (362) is a screw flight (363).

19. The polymer treatment device (300) of claim 18, wherein:
the screw flight (363) includes a plurality of deflectors (364) outwardly depending therefrom.

20. The polymer treatment device (400) of claim 17, wherein:
the mixer element (462) is a rake having a plurality of pins (463) that are arranged to depend in a helical array along an outer surface of the shaft (461).

21. The polymer treatment device (400) of claim 20 wherein:
the plurality of pins (463) are adjustably mounted to the shaft (461).

22. The polymer treatment device (400) of claim 20, wherein:
at least a subset of the plurality of pins (463) having a plurality of deflectors (464) outwardly depending therefrom.

23. The polymer treatment device (300, 400) of claim 16, wherein:
at least one of the first fluid dispenser (340, 440) and the first fluid vent (150-1) being associated with the agitator (360, 460).

24. The polymer treatment device (300, 400) of claim 17, wherein:
at least one of the first fluid dispenser (340, 440) and the first fluid vent (150-1) is associated with the agitator (360, 460), wherein:
a manifold (365, 465) is defined within the shaft (361, 461); and
a fluid channel (366, 466) is defined through at least one: i) a side wall of the shaft (361, 461); and ii) the mixer element (362, 462).

25. The polymer treatment device (400) of claim 24, further comprising:
a valve member (467) non-rotatably arranged in the manifold (465);
the valve member (467) and the manifold (465) being structured to cooperate, in use, to selectively connect the fluid channel (466) with the manifold (465) responsive to a rotation of the agitator (460).

26. The polymer treatment device (700, 800) of claim 1, wherein:
the polymer supporter (710, 810) includes:
a conveyor (711, 811) having a polymer support surface (718, 818) with perforations (717, 817) therethrough, the polymer support surface (718, 818) supports, in use, the polymer bed (4) thereon;
an enclosure (741, 841) surrounding at least a portion of the conveyor (711, 811);
the radiant heater (720, 820) being arranged within the enclosure (741, 841);
at least one of the first fluid dispenser (740-1, 840-1) and the first fluid vent (750, 850) includes:
a manifold (742-1, 842-1) arranged beneath the conveyor (711, 811) to channel the first treatment fluid (102-1) through the perforations (717, 817).

27. The polymer treatment device (700, 800) of claim 26, wherein:
the conveyor (711, 811) is one of a belt-type conveyor or a vibratory-type conveyor.

28. A molding system (1000), comprising:
the polymer treatment device (100) of claim 1 connected to an injection molding machine (50) to provide treated granules of the polymer thereto for further processing, in use, into a molded article.

29. A computer-readable medium having computer-executable instructions which, when executed by a controller that is associated with a polymer treatment device (100, 200, 300, 400, 500, 600, 700, 800) result in the polymer treatment device (100, 200, 300, 400, 500, 600, 700, 800) being operable to execute a method (2100) of providing a treatment to a polymer bed (4) that is arranged on a polymer supporter (110, 210, 310, 410, 510, 610, 710, 810) therein, the polymer bed (4) having granules (2) of a polymer that are in a solid-state, the computer-executable instructions for causing:
heating (2110) of the polymer bed (4) with radiant heat energy from a radiant heater (120, 220, 320, 420, 520, 620, 720, 820, 1020); and
passing (2120) of a first treatment fluid (102-1) through the polymer bed (4) in between the granules (2) thereof.

30. The computer-readable medium of claim 29, wherein:
the passing (2120) includes:
dispensing the first treatment fluid (102-1) from a first fluid dispenser (140-1, 240-1, 340, 440, 540, 640, 740-1, 840-1);
venting the first treatment fluid (102-1), along with a diffusate from the polymer bed (4) potentially entrained therewith, through a first fluid vent (150-1, 250, 550, 650, 750, 850).

31. The computer-readable medium of claim 30, wherein:
the heating (2110) and the passing (2120) are controlled to provide for one or more of: i) drying the granules (2) in the polymer bed (4); ii) crystallizing the granules (2) in the polymer bed (4); iii) boosting an intrinsic viscosity of the granules (2) in the polymer bed (4); iii) reducing the intrinsic viscosity of the granules (2) in the polymer bed (4).

32. The computer-readable medium of claim 30, further comprising:
conditioning the first treatment fluid (102-1) operating a first conditioning apparatus (243-1), wherein the conditioning includes one or more of: i) heating the first treatment fluid (102-1); ii) cooling the first treatment fluid (102-1); iii) dehumidifying the first treatment fluid (102-1); iv) humidifying of the first treatment fluid (102-1).

33. The computer-readable medium of claim 32, wherein:
the heating (2110) and the passing (2120) are each performed within one or more of a succession of polymer-treatment zones (z1, z2, z3, z4) that are defined along a polymer flow path within the polymer treatment device (100, 200, 300, 400, 500, 600, 700, 800).

34. The computer-readable medium of claim 33, wherein:
the conditioning includes humidifying the first treatment fluid (102-1);
the heating (2110) and the passing (2120) are each performed within a first polymer-treatment zone (z1) of the succession of polymer-treatment zones (z1, z2, z3, z4);
the heating includes heating the granules (2) of the polymer bed (4) to a crystallization temperature of the polymer;
whereby, crystallizing of the granules (2) in the polymer bed (4) is promoted.

35. The computer-readable medium of claim 34, further comprising:
conditioning of a second treatment fluid (102-2) operating a second conditioning apparatus (243-2) to perform a dehumidifying thereof;
within a second polymer-treatment zone (z2) of the succession of polymer-treatment zones (z1, z2, z3, z4):
heating of the polymer bed (4) with the radiant heat energy from the radiant heater (120, 220, 320, 420, 520, 620, 720, 820, 1020) to heat the granules (2) to a drying temperature of the polymer;
passing of the second treatment fluid (102-2) from a second fluid dispenser (140-2, 240-2, 740-2, 840-2) through the polymer bed (4) in between the granules (2) thereof;
whereby, a drying of the granules (2) in the polymer bed (4) is promoted.

36. The computer-readable medium of claim 35, further comprising:
conditioning of a third treatment fluid (602-3) operating a third conditioning apparatus (243-3) to perform the dehumidifying thereof;
within a third polymer-treatment zone (z3) of the succession of polymer-treatment zones (z1, z2, z3, z4):
heating of the polymer bed (4) with the radiant heat energy from the radiant heater (120, 220, 320, 420, 520, 620, 720, 820, 1020) to heat the granules (2) to a solid-state polymerization temperature of the polymer;
passing of the third treatment fluid (602-3) from a third fluid dispenser (240-3, 640-3, 740-3, 840-3) through the polymer bed (4) in between the granules (2) thereof;
whereby, a polymerization of the granules (2) in the polymer bed (4) is promoted for boosting an intrinsic viscosity thereof.

37. The computer-readable medium of claim 35, further comprising:
conditioning of a third treatment fluid (602-3) operating a third conditioning apparatus (243-3) to perform the dehumidifying thereof;
within a third polymer-treatment zone (z3) of the succession of polymer-treatment zones (z1, z2, z3, z4):
heating of the polymer bed (4) with the radiant heat energy from the radiant heater (120, 220, 320, 420, 520, 620, 720, 820, 1020) to heat the granules (2) to the drying temperature of the polymer;
passing of the third treatment fluid (602-3) from a third fluid dispenser (240-3, 640-3, 740-3, 840-3) through the polymer bed (4) in between the granules (2) thereof;
whereby, a decontamination of the granules (2) in the polymer bed (4) is promoted.

38. The computer-readable medium of claim 34, further comprising:
conditioning of a second treatment fluid (102-2) operating a second conditioning apparatus (243-2) to perform a humidifying thereof;
within a second polymer-treatment zone (z2) of the succession of polymer-treatment zones (z1, z2, z3, z4):
heating of the polymer bed (4) with the radiant heat energy from the radiant heater (120, 220, 320, 420, 520, 620, 720, 820, 1020) to heat the granules (2) to a solid-state degradation temperature of the polymer;
passing of the second treatment fluid (102-2) from a second fluid dispenser (140-2, 240-2, 740-2, 840-2) through the polymer bed (4) in between the granules (2) thereof;
whereby, a polymer degradation of the granules (2) in the polymer bed (4) is promoted for reducing an intrinsic viscosity thereof.

39. The computer-readable medium of claim 38, further comprising:
conditioning of a third treatment fluid (602-3) operating a third conditioning apparatus (243-3) to perform a dehumidifying thereof;
within a third polymer-treatment zone (z3) of the succession of polymer-treatment zones (z1, z2, z3, z4):
heating of the polymer bed (4) with the radiant heat energy from the radiant heater (120, 220, 320, 420, 520, 620, 720, 820, 1020) to heat the granules (2) to a drying temperature of the polymer;
passing of the third treatment fluid (602-3) from a third fluid dispenser (240-3, 640-3, 740-3, 840-3) through the polymer bed (4) in between the granules (2) thereof;
whereby, a decontaminating of the granules (2) in the polymer bed (4) is promoted.
